(19) United States
(12) Patent Application Publication
(10) Pub. No.: US 2017/0154289 A1
(43) Pub. Date: Jun. 1, 2017

(54) MAN-HOUR ESTIMATION METHOD AND MAN-HOUR ESTIMATION APPARATUS

(71) Applicant: FUJITSU LIMITED, Kawasaki-shi (JP)

(72) Inventor: Shinji Kikuchi, Yokohama (JP)

(73) Assignee: FUJITSU LIMITED, Kawasaki-shi (JP)

(21) Appl. No.: 15/272,497

(22) Filed: Sep. 22, 2016

(30) Foreign Application Priority Data
Nov. 27, 2015 (JP) 2015-232142

(51) Int. Cl. G06Q 10/06

(52) U.S. Cl. CPC G06Q 10/06313

(57) ABSTRACT

A non-transitory computer-readable recording medium storing a man-hour estimation program that causes a computer to execute a process, the process including classifying event information items recorded for each event, the event information items each recording action information items relating to actions taken with respect to the corresponding event, the event information items being classified into a plurality of categories according to a number of the recorded action information items; calculating an occurrence frequency of each word included in the event information items for each of the plurality of categories into which the event information items are classified; and estimating one of the plurality of categories to which a new event belongs, based on words included in an event information item of the new event and the calculated occurrence frequency of each word, in response to accepting the new event.

### CROSS-REFERENCE TO RELATED APPLICATION

This patent application is based upon and claims the benefit of priority of the prior Japanese Patent Application No. 2015-232142 filed on Nov. 27, 2015, the entire contents of which are incorporated herein by reference.

### FIELD

The embodiments discussed herein are related to a man-hour estimation method and a man-hour estimation apparatus.

### BACKGROUND

Incident management is known as an operation for managing information relevant to an event (hereinafter, also referred to as an “incident”) that has occurred in a predetermined system. Specifically, information relevant to an event that may be the factor causing a decrease in the service level, and action information relevant to an action taken for responding to the event, are managed in association with each other for each event that has occurred (see, for example, Patent Documents 1 through 3).

In incident management, an incident processing person responds to an incident by performing an appropriate provisional action or a permanent action, and executes a series of operations for maintaining the system in a normal state. An incident occurs according to a question from a user device operated by the user, or an alert message sent from the system, etc. An incident is managed by an incident ticket. In the incident ticket, the time when an event has occurred, the time when the action is completed, the content of the event, and action information of the action taken with respect to the event, etc., are recorded. The incident ticket is issued when a new incident has occurred. The incident processing person searches for a similar incident ticket of the past, and performs an action with respect to the new incident in consideration of the content of the past incident ticket.

Patent Document 1: Japanese Laid-Open Patent Publication No. 2007-199809

Patent Document 2: Japanese Laid-Open Patent Publication No. 2005-11140

Patent Document 3: Japanese Laid-Open Patent Publication No. 2006-059054

Patent Document 4: Japanese Laid-Open Patent Publication No. 2009-169609

Patent Document 5: Japanese Laid-Open Patent Publication No. 2011-203909

However, the approximate time and man-hours taken to perform the action are not known from the action information recorded in a past incident ticket. Therefore, it is difficult for the incident administrator to predict the approximate time and man-hours needed for performing an action with respect to a new incident by referring to the action information of a similar incident. For this reason, there is a need for information to be used as an index when the incident manger assigns an incident processing person to perform the action with respect to a new incident.

### SUMMARY

According to an aspect of the embodiments, a non-transitory computer-readable recording medium stores a man-hour estimation program that causes a computer to execute a process, the process including classifying one or more event information items recorded for each event, the one or more event information items each recording one or more action information items relating to one or more actions taken with respect to the corresponding event, the one or more event information items being classified into a plurality of categories according to a number of the recorded one or more action information items; calculating an occurrence frequency of each word included in the one or more event information items for each of the plurality of categories into which the one or more event information items are classified; and estimating one of the plurality of categories to which a new event belongs, based on one or more words included in an event information item of the new event and the calculated occurrence frequency of each word, in response to accepting the new event.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a functional block diagram of a man-hour estimation apparatus according to an embodiment of the present invention;

FIG. 2 is a diagram for describing the flow of man-hour estimation according to an embodiment of the present invention;

FIG. 3 is a diagram illustrating an example of an incident ticket according to an embodiment of the present invention;

FIG. 4 is a diagram illustrating an example of a data configuration of a past incident information DB according to an embodiment of the present invention;

FIG. 5 is a diagram illustrating another example of a data configuration of a past incident information DB according to an embodiment of the present invention;

FIG. 6 is a diagram illustrating an example of a method of classifying the incident tickets into categories according to an embodiment of the present invention;

FIG. 7 is a flowchart of an example of an incident management process according to an embodiment of the present invention;

FIG. 8 is a flowchart of an example of a likelihood function calculation process according to an embodiment of the present invention;

FIG. 9 is a diagram for describing an example of estimating a category based on a word occurrence frequency information DB and a likelihood function according to an embodiment of the present invention;

FIG. 10 is a flowchart of an example of an action man-hour estimation process according to an embodiment of the present invention; and

FIG. 11 is a hardware block diagram of the man-hour estimation apparatus according to the present embodiment.

### DESCRIPTION OF EMBODIMENTS

Preferred embodiments of the present invention will be explained with reference to accompanying drawings. Note that in the specifications and drawings, elements having substantially the same functions are denoted by the same reference numerals and redundant descriptions are omitted.

### [Incident Management]

Incident management is one of the most important and difficult tasks for maintaining the service level in system operation management. In incident management, the incident processing person performs an appropriate action with respect to an incident, and executes a series of tasks for maintaining the system in a normal state. If the incident processing person is able to estimate the man-hours needed for performing an action with respect to a new incident, based on a past incident, it is possible to efficiently implement incident management.

For example, if the incident processing person is able to extract the features of an incident that takes man-hours from among past incidents, the action and man-hours of a past incident may be applied for estimating the action and man-hours of a new incident having the same or similar features as the past incident. In this case, the incident processing person may intensively perform the actions for the new incident and significantly reduce the man-hours of the action taken for the new incident, according to the features of the new incident. Furthermore, for example, when a new incident that seems to have a high load occurs, the action for the new incident may be assigned to an experienced incident processing person or an incident processing person who has a relatively large margin in terms of man-hours, so that the operation man-hours may be levelled off and the time taken for resolving the incident may be reduced.

However, it is difficult to directly measure the man-hours taken for an action for a past event, because the man-hours are not recorded in the incident ticket, etc. Thus, it is difficult to predict the man-hours for a new incident.

Furthermore, there are cases where the period from the time when an incident is generated (occurs)(open time) to the time when the action for the incident is completed (converges)(close time), is used as the information that is generally relevant to man-hours. However, this period does not necessarily express the man-hours. One reason is that an action for each incident is not always started immediately when the incident is generated. For example, a component of a server is not always replaced immediately when a failure occurs. There may be cases where servers having a damaged component are stopped, and the components of a plurality of servers are collectively replaced at periodic frequencies such as once a month. In this case, the man-hours may be approximately the same for a failure that has occurred immediately before the periodic replacement and for a failure that has occurred immediately after the periodic replacement; however, there is a significant difference in the period until the incident ends.

Furthermore, another reason is that an e-mail may be used to send a question to a person involved (a user, etc.) in order to solve a problem when an incident occurs. However, when an e-mail is used to send the question, the timing when a response from the person involved is returned may vary depending on the individual. For this reason, when one e-mail exchange is involved in the incident, the time until the incident ends may significantly differ according to the timing of the response. Thus, in the following, a description is given of an embodiment of a man-hour estimation apparatus for estimating the man-hours of a new event.

### [Functional Configuration]

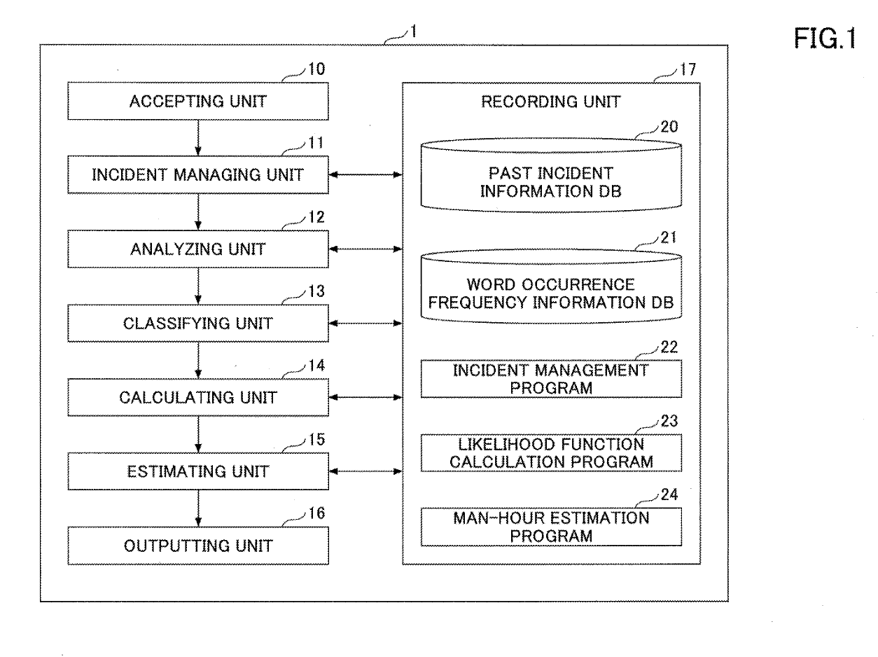

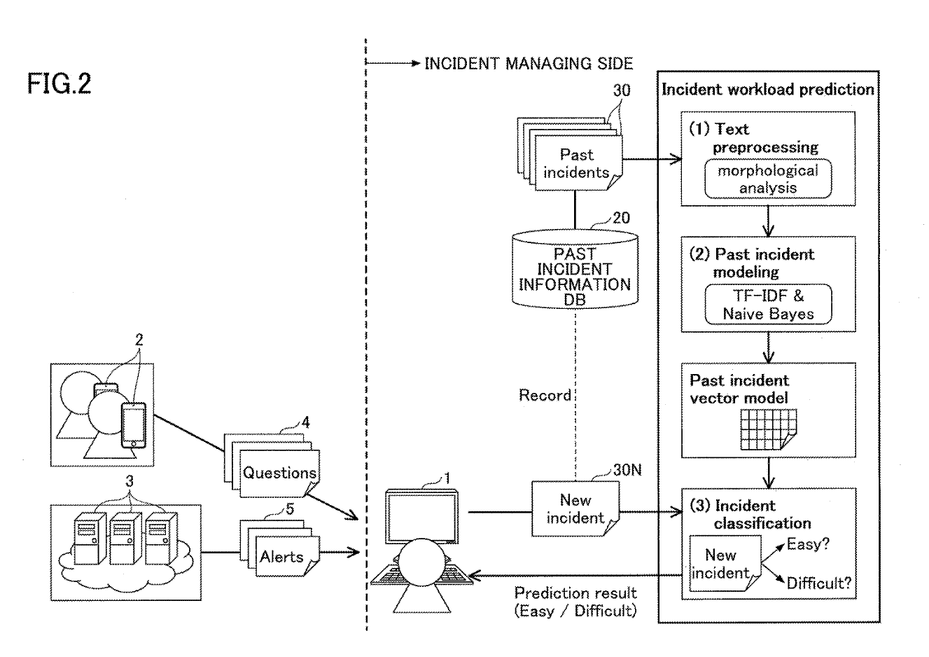

First, a description is given of an example of a functional configuration of a man-hour estimation apparatus 1 according to an embodiment of the present invention, referring to FIGS. 1 and 2. The man-hour estimation apparatus 1 according to the present invention is an example of an information processing apparatus that is capable of estimating the man-hours for each incident, with respect to incident management in a system such as an in-house salary management system, etc. However, the service that is the target of incident management is not limited to an in-house salary management system; the target of incident management may be any service that is performed by the operation of a predetermined application. The service is provided to an employee of the company or a user who is able to receive the service.

The man-hour estimation apparatus 1 according to the present embodiment includes an accepting unit 10, an incident managing unit 11, an analyzing unit 12, a classifying unit 13, a calculating unit 14, an estimating unit 15, an outputting unit 16, and a recording unit 17. The accepting unit 10 accepts a question 4 from a user device 2 operated by a user or an alert message 5 sent from a system 3, as illustrated in FIG. 2.

The incident managing unit 11 opens (generation) a new incident ticket in response to the acceptance of the question 4 from the user device 2 or the alert message 5, etc. The incident managing unit 11 closes (action completion) the new incident ticket, when the action for the new incident ticket is completed. An incident is an event that may be the factor causing the decrease in the service level that has occurred in a predetermined system. An incident is managed by an incident ticket. In the incident ticket, the time when the event has occurred, the completion time of the action, the content of the event, and the information of the action taken for the event, etc., are recorded. When a new incident occurs, the incident administrator searches for a similar incident ticket, and performs an action for the new incident based on the information in the incident ticket that is found.

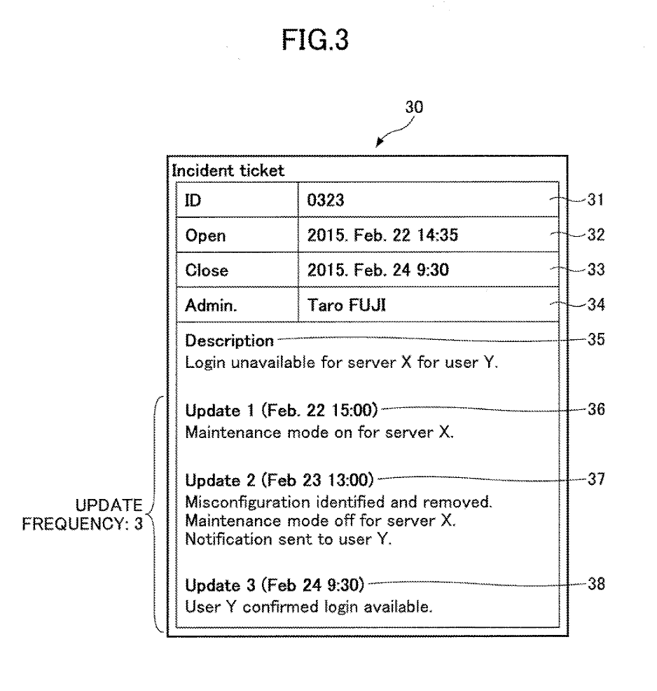

As illustrated in FIG. 3, in an incident ticket, information relevant to an incident is recorded. For example, in an incident ticket 30, the following items (a) through (e) are recorded. The following items in the incident ticket are examples of event information including the content of an incident and one or more action information items with respect to the incident.
(a) Incident ID 31: A number that is uniquely assigned to each incident.
(b) Open Time 32: An incident generation (occurrence) time.
(c) Close Time 33: An incident action completion (convergence) time.
(d) Admin. name 34: The name of the incident processing person.
(e) Description 35: The content of the incident (one or more action information items are recorded)

In the description 35 (hereinafter, also referred to as an “incident description 35”), the occurrence of an event and the progress of the action, etc., are recorded as the content of the incident. Therefore, the incident ticket 30 may be overwritten (updated) according to the progress. Examples of timings when the incident ticket 30 is updated are when writing in the time and date of incident close in the field of close time 33, when writing in the change in the person in charge in the field of the admin. name 34, and when writing in the progress of the action (shifting to the maintenance mode, finding the cause of the problem, etc.). In FIG. 3, as the progress of the action, three update information items 36, 37, and 38 are written in the incident ticket 30. In this way, it is possible to determine the number of times the incident has been updated, by referring to the incident description 35 of the incident ticket 30.

Thus, in the present embodiment, the load of the task for responding to the incident (incident action task) is predicted by using the number of times the content of the incident description 35 is updated (update frequency). That is, when the frequency of updating the action content is high in the incident ticket, it is deemed that many tasks are needed for responding to the incident, and that the man-hours of the action for the incident are many, i.e., the load of the incident action task is high.

The prediction of the load of the incident action task indicated in the frame of FIG. 2 is performed by executing the steps indicated in (1) through (3) mainly by the analyzing unit 12, the classifying unit 13, and the calculating unit 14 or the estimating unit 15 of FIG. 1.

In step (1), the analyzing unit 12 calculates the update frequency of the incident tickets, and the classifying unit 13 classifies the incident tickets into a plurality of categories based on the calculated update frequency. Furthermore, the calculating unit 14 counts the number of times a word appears within each incident ticket.

In step (2), the calculating unit 14 obtains the correlation between the categories into which the incident tickets are classified and the occurrence frequency of each type of word. For example, the calculating unit 14 uses an index of TF-IDF (term frequency/inverse document frequency), etc., to calculate the occurrence tendency of a word in each category. Accordingly, it is possible to extract a word (keyword), etc., unique to the incidents included in each category.

In step (3), with respect to a new incident, the estimating unit 15 estimates which category has features that are close to those of the new incident. For example, the estimation is done by determining whether the new incident includes many keywords that are unique to a certain category among a plurality of categories into which the incidents are classified according to whether the update frequency is high or low. Then, the estimating unit 15 may estimate the man-hours of an action for the new incident, based on the update frequency of a past incident included in the category having features that are close to the features of the new incident.

The outputting unit 16 outputs the estimated man-hours of an action for a new incident. Accordingly, the incident administrator is able to determine the person to whom to assign the new incident that has occurred, among a plurality of incident processing persons.

The recording unit 17 records a past incident information DB 20, a word occurrence frequency information DB 21, an incident management program 22, a likelihood function calculation program 23, and a man-hour estimation program 24, as illustrated in FIG. 1.

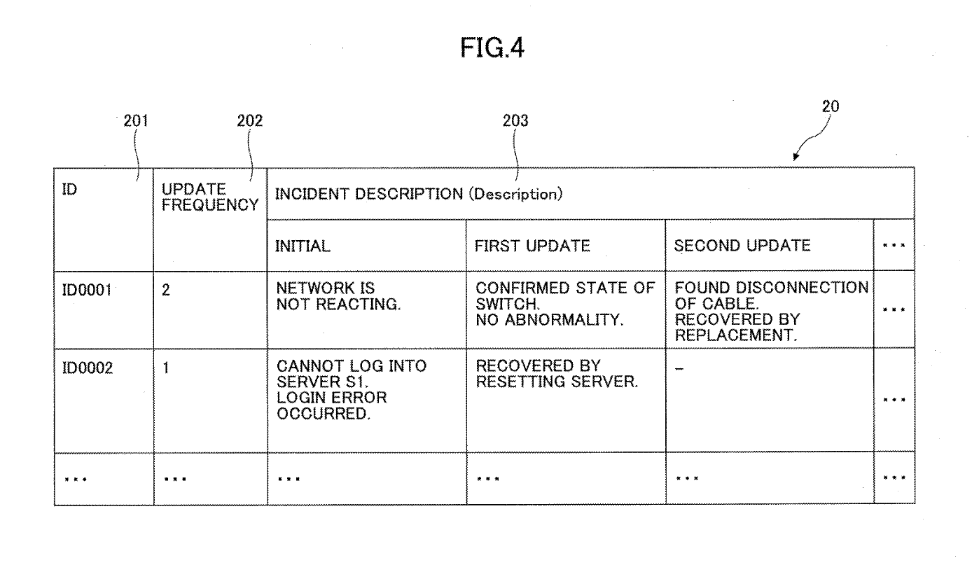

FIG. 4 is a diagram illustrating a data configuration of the past incident information DB 20 according to an embodiment of the present invention. The past incident information DB 20 includes the items of an incident ID 201, an update frequency 202, and an incident description 203. In the incident ID 201, the incident ID 31 of the incident ticket 30 is recorded. In the update frequency 202, the frequency of the update information recorded in the incident description 35, is recorded. In the incident description 203, the content recorded in the incident description 35 at the initial time and every time the content is updated, is recorded.

For example, in the past incident information DB 20 of FIG. 4, in the incident having the incident ID 201 of “ID0001”, “2 times” is recorded as the update frequency 202. Furthermore, in the incident description 203 of the incident, “Network is not reacting.” is recorded for the initial time, “Confirmed state of switch. No abnormality.” is recorded for the first update, and “Found disconnection of cable. Recovered by replacement.” is recorded for the second update.

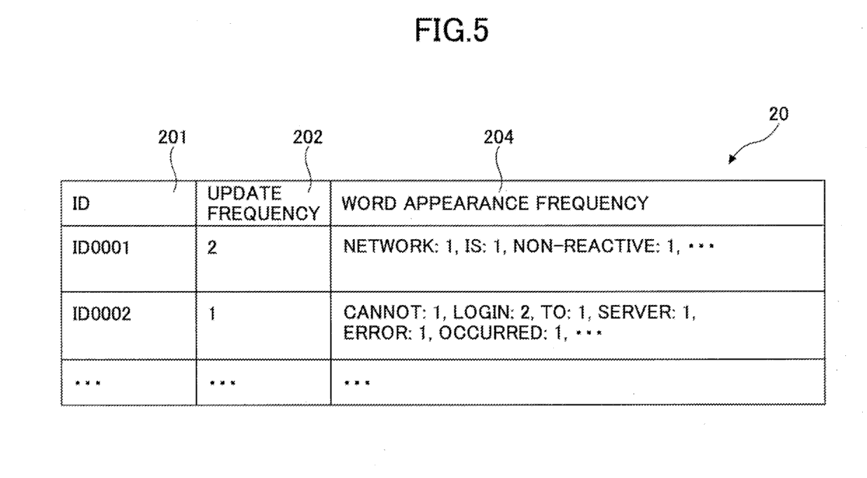

FIG. 5 is a diagram illustrating another example of the data configuration of the past incident information DB 20 according to an embodiment of the present invention. The past incident information DB 20 includes the items of the incident ID 201, the update frequency 202, and a word appearance frequency 204. In the word appearance frequency 204, the appearance frequency of words recorded in the incident description 35 is recorded for each type of word. Note that the analyzing unit 12 analyzes the content recorded in the incident description 35, and the calculating unit 14 extracts the words and counts the appearance frequency of each type of word.

For example, in the past incident information DB 20 of FIG. 5, in the incident having the incident ID 201 of “ID0001”, “2 times” is recorded as the update frequency 202. Furthermore, in the word appearance frequency 204, “1 time” is recorded as the appearance frequency of the word “network”, “1 time” is recorded as the appearance frequency of the word “is”, and “1 time” is recorded as the appearance frequency of the word “non-reactive”, and so on.

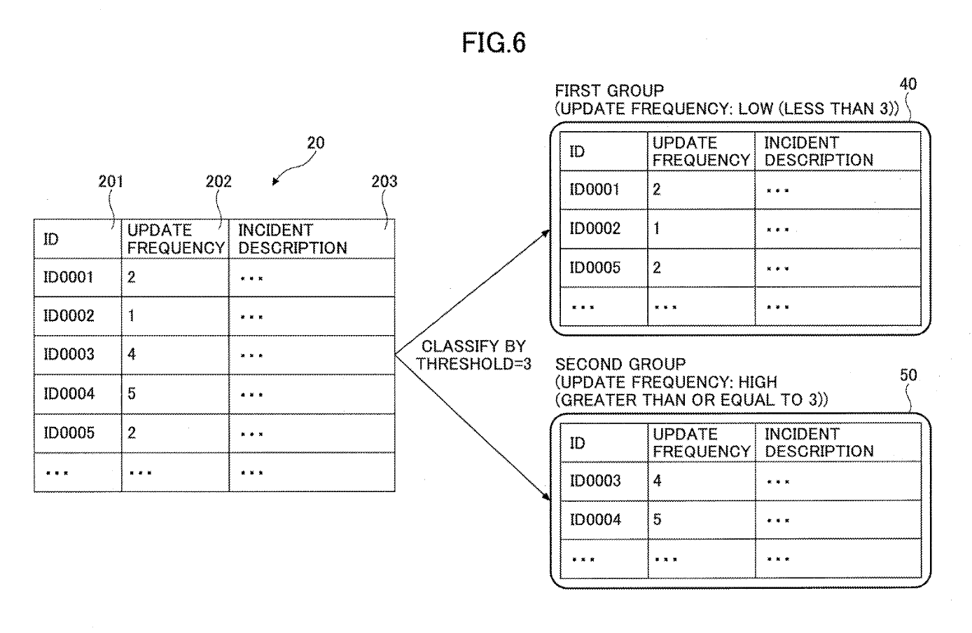

Based on the update frequency 202 of each incident recorded in the past incident information DB 20 as described above, the incident tickets are classified into a plurality of categories. A description is given of a method of classifying the incident tickets into categories, executed by the classifying unit 13, referring to FIG. 6. The classifying unit 13 sets a threshold (for example, 3) in advance. This threshold is used by the classifying unit 13 for determining whether the update frequency of an incident is high or low, before classifying the incident tickets according to the update frequency of the incident. Based on the set threshold, the classifying unit 13 classifies the incident tickets recorded in the past incident information DB 20 into a first group 40 of a low update frequency and a second group 50 of a high update frequency. The category of the first group 40 includes incident tickets having an update frequency of less than 3. The category of the second group 50 includes incident tickets having an update frequency of greater than or equal to 3.

The classifying unit 13 may divide the incident tickets into three or more groups, by specifying a plurality of thresholds. For example, the classifying unit 13 may set a first threshold and a second threshold. The first threshold may be used for classifying the incident tickets having a low update frequency (for example, 0 through 2 times) and incident tickets having a medium update frequency (for example, 3 through 5 times). The second threshold may be used for classifying the incident tickets having a medium update frequency (for example, 3 through 5 times) and incident tickets having a high update frequency (for example, greater than 5 times).

However, the method of determining the thresholds are not so limited, and a plurality of methods may be used. For example, the threshold may be set to a predetermined fixed value. For example, the classifying unit 13 may set the threshold as “3” in advance, classify the incident tickets having an update frequency of less than 3 into a category of a low update frequency, and classify the incident tickets having an update frequency of greater than or equal to 3 into a category of a high update frequency.

Furthermore, a threshold may be set by using a predetermined statistic. For example, the threshold may be determined from the values of “X” and “Y”, by using the relationship that X % of all incident tickets have an update frequency of less than or equal to Y. For example, when 90% of all of the incident tickets have an update frequency of less than or equal to 4, incident tickets having an update frequency of less than or equal to 4 (90% of all incident tickets) may be classified into a category of a low update frequency. Incident tickets having an update frequency of greater than or equal to 5 (10% of all incident tickets) may be classified into a category of a high update frequency.

Furthermore, the threshold may be calculated based on the incident response capability of an incident processing person to which the system administrator assigns an incident. In this case, the classifying unit 13 digitizes the response capabilities of the incident processing persons and divides the response capabilities into categories, and assigns the incidents according to the ratio. For example, there is a group (group A) including six persons having a capability value of “0.5 (low)”, and a group (group B) including two persons having a capability value of “1.0 (high)”. The capability values of the respective groups are “3.0” (=6×0.5) for group A and “2.0” (=2×1.0) for group B. Thus, the threshold may be set such that the incident tickets having a low update frequency, which is 60% (=3.0/(3.0+2.0)) of all of the incident tickets, are assigned to group A. Specifically, when 60% of all incident tickets have an update frequency of less than or equal to 3 times, the incident tickets having an update frequency of less than or equal to 3 times (60% of all incident tickets) may be classified into a category of a low update frequency. The incident tickets having an update frequency of greater than or equal to 4 times (40% of all incident tickets) may be classified into a category of a high update frequency.

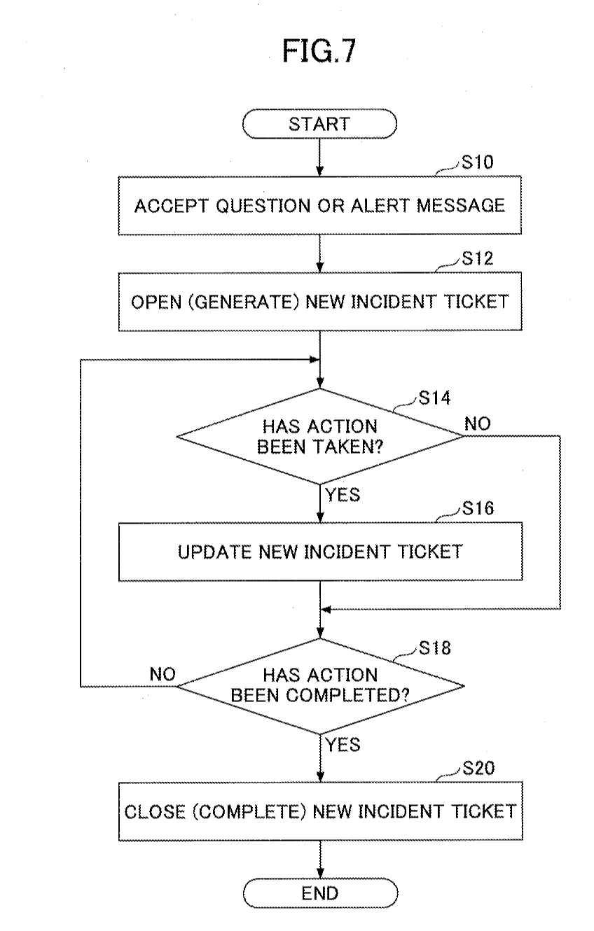

Referring back to FIG. 1, the incident management program 22 recorded by the recording unit 17 is a program for causing the man-hour estimation apparatus 1 to execute an incident management process. In the incident management program 22, mainly the steps indicated in the incident management process of FIG. 7 are described.

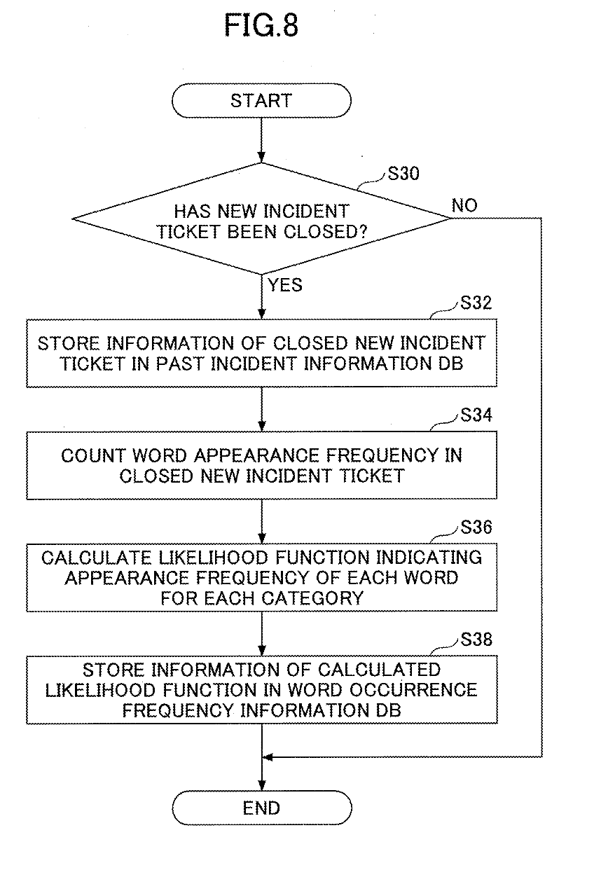

The likelihood function calculation program 23 is a program for causing the man-hour estimation apparatus 1 to execute a likelihood function calculation process. In the likelihood function calculation program 23, mainly the steps indicated in the likelihood function calculation process of FIG. 8 are described.

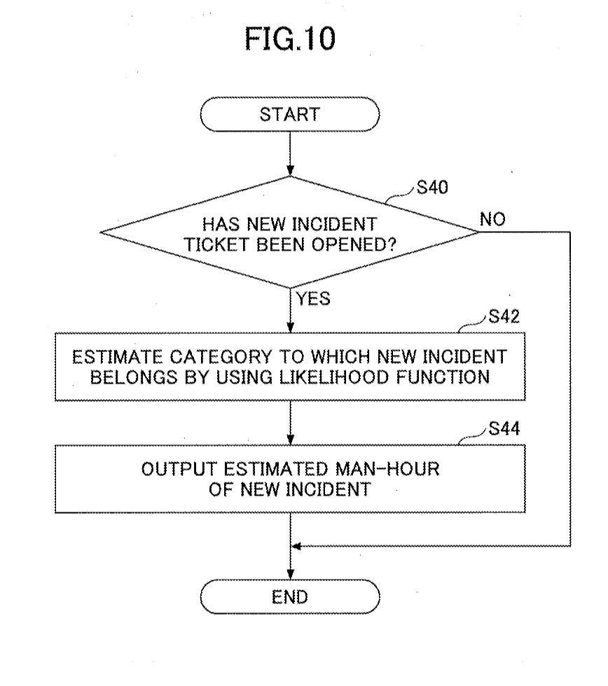

The man-hour estimation program 24 is a program for causing the man-hour estimation apparatus 1 to execute an action man-hour estimation process. In the man-hour estimation program 24, mainly the steps indicated in the action man-hour estimation process of FIG. 10 are described.

### [Incident Management Process]

Next, a description is given of an incident management process according to an embodiment of the present invention, referring to FIG. 7. FIG. 7 is a flowchart of an example of an incident management process according to an embodiment of the present invention. When the present process is started, the accepting unit 10 accepts a question from the user device 2 or an alert message from the system 3, etc. (step S10).

Next, the incident managing unit 11 opens (generates) a new incident ticket when the question, etc., is accepted (step S12). Next, the incident managing unit 11 determines whether the incident processing person has performed some kind of action (step S14). When the incident managing unit 11 determines that the incident processing person has performed some kind of action, the incident managing unit 11 records the action content in the new incident ticket, updates the new incident ticket (step S16), and proceeds to step S18. Specifically, the incident managing unit 11 records the action content in the incident description 35 of the incident ticket 30 in FIG. 3, and updates the new incident ticket. When the incident managing unit 11 determines that the incident processing person has not performed any actions, the incident managing unit 11 immediately proceeds to step S18.

Next, the incident managing unit 11 determines whether the action for the new incident has been completed (step S18). When the incident managing unit 11 determines that the action for the new incident has not been completed, the incident managing unit 11 returns to step S14 and repeats the processes of steps S14 through S18 until the action is completed. When the incident managing unit 11 determines that the action for the new incident has been completed, and the action for the new incident ticket is completed, the incident managing unit 11 closes (action completion) the new incident ticket (step S20), and ends the present process.

A likelihood function calculation process using an incident ticket that is generated and managed as described above, and an action man-hour estimation process using the likelihood function, are sequentially described.

### [Likelihood Function Calculation Process]

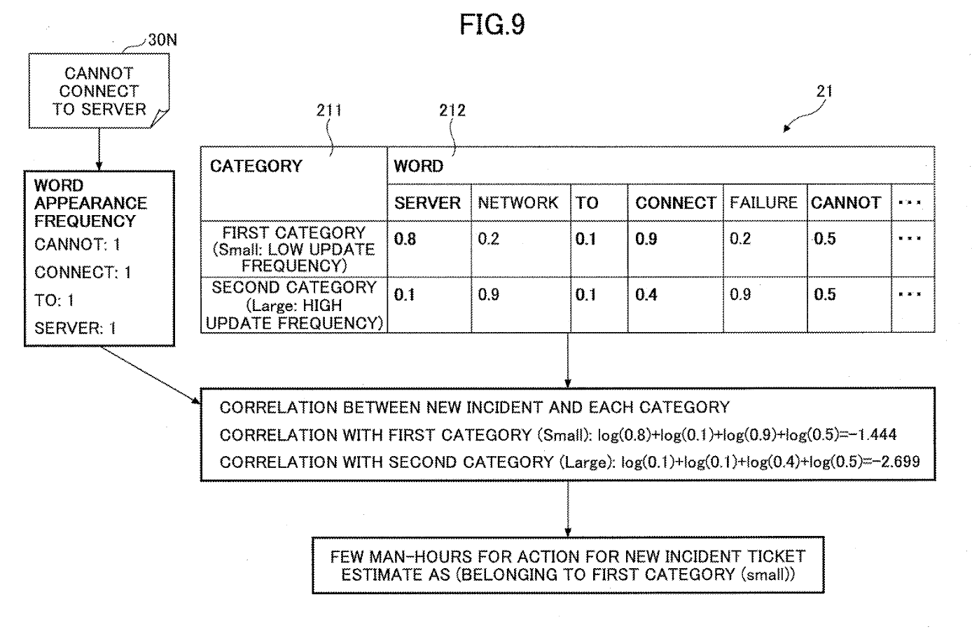

A description is given of a likelihood function calculation process according to an embodiment of the present invention, referring to FIGS. 8 and 9. FIG. 8 is a flowchart of an example of a likelihood function calculation process according to an embodiment of the present invention. FIG. 9 is a diagram for describing an example of the calculation of the likelihood function according to an embodiment of the present invention.

When the present process is started, the calculating unit 14 determines whether the new incident ticket has been closed (step S30). When the calculating unit 14 determines that the new incident ticket has not been closed, the calculating unit 14 ends the present process without performing any further processes. When the calculating unit 14 determines that the new incident ticket has been closed, the recording unit 17 stores event information (event content) recorded in the new incident ticket that has been closed, in the past incident information DB 20 (step S32). Examples of the event information stored in the past incident information DB 20 are the incident ID 31, the update frequency corresponding to the update information 36, 37, and 38, and the incident description 35 indicated in FIG. 3. The open time 32, the close time 33, and the admin. name 34 may also be stored in the past incident information DB 20.

Referring back to FIG. 8, next, the calculating unit 14 counts the appearance frequency of words included in the new incident ticket that has been closed (step S34). The calculating unit 14 may count the appearance frequency of words recorded in the incident description 35 for each type of word.

Next, the calculating unit 14 calculates the likelihood function indicating the appearance tendency of each word in each category (step S36). The recording unit 17 stores, in the word occurrence frequency information DB 21, the appearance frequency of each type of word by category that is calculated based on the information of the calculated likelihood function (step S38), and ends the present process.

### (Likelihood Function)

A description is given of an example of the method of calculating a likelihood function executed by the calculating unit 14 in step S36. The calculating unit 14 identifies, for each of the two categories (a category of a high update frequency and a category of a low update frequency), the correlation between the category and the occurrence frequency of words included in the incident tickets of each category. The calculating unit 14 uses an index such as TF-IDF to calculate the tendency of the occurrence frequency of words of each category.

In the calculation, an assembly of past incident tickets is indicated by T={t₁, t₂ . . . }(for example, t₁=ID0001, t₂=ID0002 . . . ). Furthermore, an assembly of words included in the entire ticket is indicated by W={w₁, w₂ . . . }(for example, w₁=“server”, w₂=“connection” . . . ). In formula (1) , “i” indicates each type of word appearing in all of the incidents. Furthermore, “w” indicates the total number of types of words appearing in all of the incidents.

### (A) Calculation of tf

First, the calculating unit 14 calculates tf (term frequency) based on the following formula (1).

$$\begin{matrix}Formula ( 1 ) & \\ tf ( {w}_{i} , {t}_{j} ) = \frac{{n}_{i , j}}{{\sum }_{k} {n}_{k , j}} & ( 1 )\end{matrix}$$

Tf is an index expressing how frequently a word wᵢ appears in the text tj of the incident ticket. As tf becomes higher, the frequency of the word appearing in the incident ticket increases. For example, when a text, which is recorded in the incident description 35 of the incident ticket having an incident ID “ID0002”, includes the seven words of “Cannot login to server. Login error occurred.”, the tf of each of the words “server” and “login” is calculated as follows.

tf(“server”, ID0002)=1/7

tf(“login”, ID0002)=2/7

### (B) Calculation of idf

However, a word that appears frequently in all of the incident tickets is not a word that is unique to a particular incident ticket. That is, a word that appears frequently in all of the incident tickets is determined to be unimportant even if the tf is high. Thus, the calculating unit 14 calculates the idf (inverse document frequency) Based on the following formula (2).

$$\begin{matrix}Formula ( 2 ) & \\ idf ( {w}_{i} ) = log \frac{\vert T \vert}{{\sum }_{k} δ ( {w}_{i} , {t}_{k} )} \\ δ ( {w}_{i} , {t}_{k} ) = \{ \begin{matrix}1 \text{:} & text {t}_{k} includes word {w}_{i} \\ 0 \text{:} & O therwise\end{matrix} & ( 2 )\end{matrix}$$

In formula (2), idf expresses how much the word w₁has a low appearance frequency in the overall assembly of incident tickets, that is, whether the word is uniquely used only in a particular incident ticket. As the idf becomes higher, the extent of the word being unique to a particular incident ticket (having a high frequency) increases. For example, when the word “server” appears in 10 incident tickets out of a total of 100 incident tickets, the idf of the word “server” in the incident having the incident ID of ID0002 is calculated as follows.

idf(“server”, ID0002)=log(100/10)

When δ (w₁, tₖ) of formula (2) is 1, this indicates that the text tₖ of the incident ticket includes the word w₁. When δ (w₁, tₖ) is 0, this indicates that the text tₖ of the incident ticket does not include the word w₁.

### (C) Calculation of f

Next, the calculating unit 14 calculates TF-IDF indicating an example of the occurrence tendency of a word in each category. TF-IDF is obtained by multiplying tf by idf, and is indicated by f_{i, j}. The calculating unit 14 calculates f_{i, j} based on the following formula (3).

Formula (3)

f_{i,j}=tf(wᵢ,tⱼ)·idf(w₁) (3)

In formula (3), f_{i, j} indicates the correlation between a word w₁and the text tj of the incident ticket. When the appearance frequency of the word w₁ is high in the text tj of the incident ticket, and the appearance frequency of the word w₁ is low in the text of other incident tickets, the value of f_{i, j} becomes high. For example, f_{i, j} of the word “server” in the incident ticket t₂ of ID0002 is calculated as follows.

f_{server, ID0002}=tf(“server”, ID0002)·idf(“server”)=1/7·log(100/10)=0.143

Note that the calculation of f is performed for the texts of all incident tickets belonging to each category.

### (D) Likelihood Function θ

Next, the calculating unit 14 calculates the appearance frequency of each word as the likelihood, for the respective categories of a category of a high update frequency and a category of a low update frequency. The likelihood function indicates the appearance tendency of a word in each category. Specifically, the calculating unit 14 calculates the tendency (likelihood) that the word w₁ appears in the text of the incident tickets belonging to the respective categories of a category of a high update frequency and a category of a low update frequency, based on the following formula (4).

$$\begin{matrix} Formula ( 4 ) & \\ {\hat{θ}}_{c , i} = \frac{{\sum }_{j \text{:} l ( {t}_{j} ) = c} {f}_{i , j} + 1}{{\sum }_{j \text{:} l ( {t}_{j} ) = c} {\sum }_{k} {f}_{k , j} + \vert W \vert} \\ l ( {t}_{j} ) = \{ \begin{matrix}small \text{:} & {WHEN UPDATE FREQUENCY OF TEXT tj OF}_{INCIDENT TICKET IS LESS THAN THRESHOLD} \\ large \text{:} & OTHER THAN THE ABOVE\end{matrix} & ( 4 )\end{matrix}$$

When l(tⱼ) of formula (4) is small, this indicates that the update frequency of the text tj of the incident ticket is less than a threshold, and when l(tⱼ) is large, this indicates that the update frequency of the text tj of the incident ticket is greater than or equal to than a threshold. The likelihood function θ is recorded as the appearance frequency of a word in each category, for example, in a field of word 212 for each category 211 in the word occurrence frequency information DB 21 illustrated in FIG. 9. In the example of FIG. 9, “0.8” is recorded as the occurrence frequency of the word “server” in the incident ticket included in the first category (small: low update frequency) among the categories 211.

### [Action Man-Hour Estimation Process]

Next, a description is given of an action man-hour estimation process according to the present embodiment, referring to FIG. 10. FIG. 10 is a flowchart of an example of an action man-hour estimation process according to an embodiment of the present invention.

When the present process is started, the estimating unit 15 determines whether a new incident ticket has been opened (step S40). When the estimating unit 15 determines that a new incident ticket has not been opened, the estimating unit 15 ends the present process without performing any further processes. When the estimating unit 15 determines that a new incident ticket has been opened, the estimating unit 15 uses a likelihood function to estimate the category to which the opened new incident ticket belongs (step S42). Next, the outputting unit 16 outputs the estimated category to which the new incident ticket belongs (step S44), and ends the present process.

### (Man-Hour Estimation)

A description is given of an example of a method of estimating a category executed by the estimating unit 15 in step S42. In step S42, the estimating unit 15 digitizes the estimation result of the category to which a text t_{new} of the new incident ticket belongs, based on the following formula (5). That is, the estimating unit 15 obtains, by calculation, which category the new incident ticket is more likely to belong to, based on formula (5).

$$\begin{matrix}Formula ( 5 ) & \\ \hat{l} ( {t}_{new} ) = {argmax}_{c} {\sum }_{i} ( {d}_{i} \cdot log {\hat{θ}}_{c , i} ) \\ {d}_{i} \text{:} APPEARANCE FREQUENCY OF WORD \\ {w}_{i} IN TEST {t}_{new} OF NEW INCIDENT TICKET & ( 5 )\end{matrix}$$

In formula (5), dᵢ indicates the appearance frequency of the word wᵢ in the text t_{new} of the new incident ticket. In formula (5), the value of Σd·log θ is calculated for all categories, and the maximum value among the calculated values is output as the estimation result of a category.

For example, in the example of FIG. 9, with respect to the text of a new incident ticket 30N “cannot connect to server”, the calculating unit 14 counts the appearance frequency to be one time for each of the words “cannot”, “connect”, “to”, “server”, in step S34 of FIG. 8.

In this case, the estimating unit 15 calculates the correlation value between the new incident ticket 30N and each category as follows by using a likelihood function.

$$Correlation value with first category ( small ) = 1 \times log ( 0.8 ) + 1 \times log ( 0.1 ) + 1 \times log ( 0.9 ) + 1 \times log ( 0.5 ) = - 1.444$$

$$Correlation value with second category ( large ) = 1 \times log ( 0.1 ) + 1 \times log ( 0.1 ) + 1 \times log ( 0.4 ) + 1 \times log ( 0.5 ) = - 2.699$$

In the example of FIG. 9, according to the above results, the estimating unit 15 estimates that the new incident ticket 30N belongs to a first category (small) having a high correlation value, and that the new incident ticket 30N needs few man-hours for an action similar to past incident tickets belonging to the first category (small). The outputting unit 16 outputs the name (low update frequency, high update frequency, etc.) of the category estimated as the category to which the new incident ticket belongs.

As described above, the man-hour estimation apparatus 1 according to an embodiment calculates the appearance frequency of each word appearing in the field of the incident description 35, for each category. Accordingly, the man-hour estimation apparatus 1 is able to estimate the category into which the new incident ticket is to be classified, based on the calculated appearance frequency of each word. Accordingly, the man-hour estimation apparatus 1 is able to predict the man-hours of the action of the new incident ticket, based on the estimated category. As a result, the system administrator is able to determine the person among a plurality of incident processing persons to which the new incident is to be assigned.

### (Hardware Configuration)

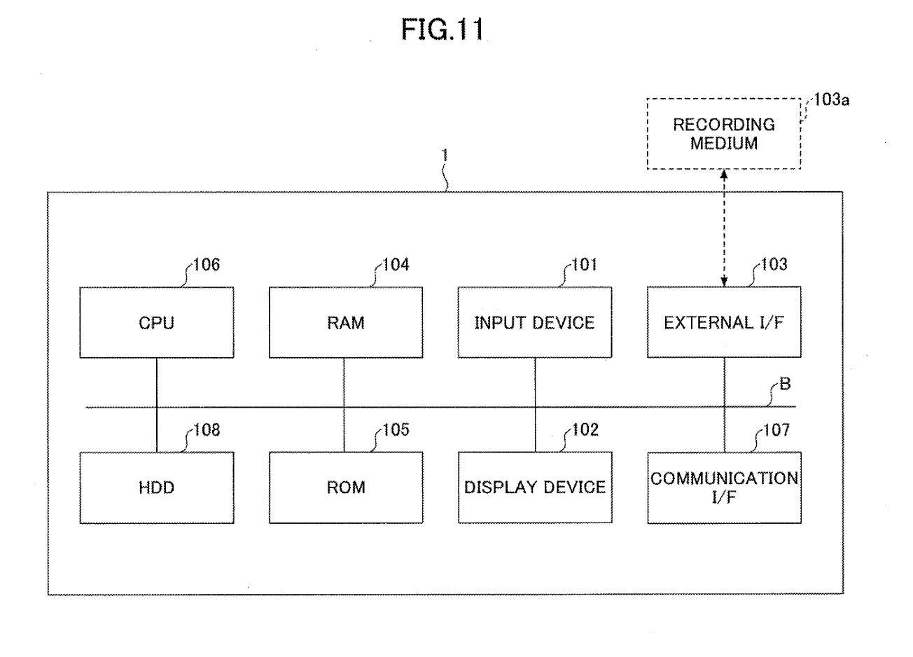

Lastly, a description is given of an example of a hardware configuration of the man-hour estimation apparatus 1 according to the present embodiment, referring to FIG. 11. The man-hour estimation apparatus 1 includes an input device 101, a display device 102, an external interface (I/F) 103, a Random Access Memory (RAM) 104, a Read-Only Memory (ROM) 105, a Central Processing Unit (CPU) 106, a communication I/F 107, and a Hard Disk Drive (HDD) 108, which are interconnected by a bus B.

The input device 101 includes a keyboard and a mouse, etc., and is used for inputting various operation signals in the man-hour estimation apparatus 1. The display device 102 includes a display, and displays various processing results. The communication I/F 107 is an interface for connecting the man-hour estimation apparatus 1 to a network. Accordingly, the man-hour estimation apparatus 1 is able to perform data communication with another device (a terminal XYZ, etc.) via the communication I/F 107.

The HDD 108 is a non-volatile storage device storing programs and data. The stored programs and data include basic software for controlling the entire man-hour estimation apparatus 1 and application software. For example, the HDD 108 may store various databases and programs, etc.

The external I/F 103 is an interface between the man-hour estimation apparatus 1 and an external device. An example of an external device is a recording medium 103a. Accordingly, the man-hour estimation apparatus 1 is able to read and/or write in the recording medium 103a via the external I/F 103. Examples of the recording medium 103a are a Compact Disk (CD), a Digital Versatile Disk (DVD), an SD memory card, and a Universal Serial Bus (USB) memory, etc.

The ROM 105 is a non-volatile semiconductor memory (storage device) that is able to store internal data even after the power is turned off. The ROM 105 stores programs and data such as network settings. The RAM 104 is a volatile semiconductor memory (storage device) for temporarily storing programs and data. The CPU 106 is an arithmetic device for controlling the entire device and realizing the installed functions, by reading loading programs and data from the above storage devices (for example, the HDD 108 and the ROM 105) into the RAM 104, and executing processes.

By the above configuration, in the man-hour estimation apparatus 1 according to the present embodiment, the CPU 106 executes the incident management process, the likelihood function calculation process, and the action man-hour estimation process, by using data stored in the ROM 105 and the HDD 108, the incident management program 22, the likelihood function calculation program 23, the man-hour estimation program 24, and other programs. Note that the information stored in the past incident information DB 20 and the word occurrence frequency information DB 21 may be stored in the RAM 104, the HDD 108, or a server, etc., of a cloud service connected to the man-hour estimation apparatus 1 via a network.

According to an aspect of the embodiments, a man-hour estimation method and a man-hour estimation apparatus are provided, which are capable of estimating the man-hours with respect to a new event.

The man-hour estimation method and the man-hour estimation apparatus are not limited to the specific embodiments described herein, and variations and modifications may be made without departing from the scope of the present invention. Furthermore, a plurality or embodiments or modified examples may be combined as long as there are no contradictions.

For example, the configuration of the man-hour estimation apparatus according to the above embodiment does not limit the scope of the present invention, and there may be various examples of the configuration according to the purpose and objective. For example, the system configuration in which the man-hour estimation apparatuses are connected via a network may include one or more devices for executing an application (man-hour estimation program) for estimating man hours among one or more applications for performing event incident management. The man-hour estimation apparatus may be a device in a data center or a server in a cloud service, etc.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a man-hour estimation program that causes a computer to execute a process, the process comprising:
classifying one or more event information items recorded for each event, the one or more event information items each recording one or more action information items relating to one or more actions taken with respect to the corresponding event, the one or more event information items being classified into a plurality of categories according to a number of the recorded one or more action information items;
calculating an occurrence frequency of each word included in the one or more event information items for each of the plurality of categories into which the one or more event information items are classified; and
estimating one of the plurality of categories to which a new event belongs, based on one or more words included in an event information item of the new event and the calculated occurrence frequency of each word, in response to accepting the new event.

2. The non-transitory computer-readable recording medium according to claim 1, the process further comprising:
outputting information relating to the estimated one of the plurality of categories to which the new event belongs.

3. A method for estimating man-hours executed by a computer, the method comprising:
classifying one or more event information items recorded for each event, the one or more event information items each recording one or more action information items relating to one or more actions taken with respect to the corresponding event, the one or more event information items being classified into a plurality of categories according to a number of the recorded one or more action information items;
calculating an occurrence frequency of each word included in the one or more event information items for each of the plurality of categories into which the one or more event information items are classified; and
estimating one of the plurality of categories to which a new event belongs, based on one or more words included in an event information item of the new event and the calculated occurrence frequency of each word, in response to accepting the new event.

4. The method according to claim 3, further comprising:
outputting information relating to the estimated one of the plurality of categories to which the new event belongs.

5. A man-hour estimation apparatus comprising:
a processor configured to execute a process including
classifying one or more event information items recorded for each event, the one or more event information items each recording one or more action information items relating to one or more actions taken with respect to the corresponding event, the one or more event information items being classified into a plurality of categories according to a number of the recorded one or more action information items,
calculating an occurrence frequency of each word included in the one or more event information items for each of the plurality of categories into which the one or more event information items are classified, and
estimating one of the plurality of categories to which a new event belongs, based on one or more words included in an event information item of the new event and the calculated occurrence frequency of each word, in response to accepting the new event.

6. The man-hour estimation apparatus according to claim 5, the process further comprising:
outputting information relating to the estimated one of the plurality of categories to which the new event belongs.
